(19) United States
(12) Patent Application Publication
(10) Pub. No.: US 2020/0341602 A1
(43) Pub. Date: Oct. 29, 2020

(54) TRAINING A MACHINE LEARNING ENGINE TO SCORE BASED ON USER PERSPECTIVE

(71) Applicant: salesforce.com, inc., San Francisco, CA (US)

(72) Inventors: Owen Winne Schoppe, Orinda, CA (US); Brian J. Lonsdorf, Belmont, CA (US); Sönke Rohde, San Francisco, CA (US)

(21) Appl. No.: 16/393,180

(22) Filed: Apr. 24, 2019

(51) Int. Cl. G06F 3/0484; G06F 3/0481

(52) U.S. Cl. CPC G06F 3/0484; G06F 3/04817

(57) ABSTRACT

Disclosed techniques relate to scoring input elements independently, based on user comparison inputs for training data. In some embodiments, for a set of training elements, a system displays subsets to users and receives user input indicating ones of the subsets that more strongly exhibit a specified user interface design parameter relative to other user interface elements in that subset. In some embodiments, a ranking technique such as Bradley-Terry techniques generate a ranking of the user interface elements according to the design parameter based on the user input. In some embodiments, the system trains a machine learning engine to score a subsequently presented input user interface element according to the design parameter, using outputs of the ranking as labels.

### BACKGROUND

### Technical Field

Embodiments described herein relate to user interface technology and, in particular, to machine learning techniques for scoring user interface elements according to design parameters.

### Description of the Related Art

User interfaces are often generated by multiple skilled designers, e.g., to combine quality coding techniques with graphical design to achieve desired functionality while pleasing the eye, achieving branding goals, or promoting desired user behaviors. Many entities may desire customized interfaces rather than using generic templates. Many entities do not have access, however, to coding or design expertise needed to generate an effective user experience.

### BRIEF DESCRIPTION OF THE DRAWINGS

FIG. 1 is a block diagram illustrating an example system configured to train a machine learning engine, according to some embodiments.

FIG. 2 is a diagram illustrating an example user interface for receiving user input used to generate training labels, according to some embodiments.

FIG. 3 is a diagram illustrating example Bradley-Terry weights and neural network scores, according to some embodiments.

FIG. 4 is a diagram illustrating an example user interface for scoring user interface elements, according to some embodiments.

FIG. 5 is a flow diagram illustrating an example method for training a machine learning engine, according to some embodiments.

FIG. 6 is a diagram illustrating an example neural network topology, according to some embodiments.

FIG. 7 is a block diagram illustrating an example computing system, according to some embodiments.

This disclosure includes references to “one embodiment,” “a particular embodiment,” “some embodiments,” “various embodiments,” “an embodiment,” etc. The appearances of these phrases do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. For example, a “machine learning engine configured to score input data” is intended to cover, for example, equipment that has a program code or circuitry that performs this function during operation, even if the circuitry in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a”, “an”, and “the” include singular and plural referents unless the context clearly dictates otherwise. Furthermore, the words “can” and “may” are used throughout this application in a permissive sense (i.e., having the potential to, being able to), not in a mandatory sense (i.e., must). The term “include,” “comprise,” and derivations thereof, mean “including, but not limited to.” The term “coupled” means directly or indirectly connected.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used herein, the term “or” is used as an inclusive or and not as an exclusive or. For example, the phrase “at least one of x, y, or z” means any one of x, y, and z, as well as any combination thereof (e.g., x and y, but not z or x, y, and z).

### DETAILED DESCRIPTION

Many design parameters for creating customized user interfaces, such as “emphasis” of certain elements, may be difficult for computer systems to measure, particularly independently of other elements. Rather, these design parameters may be intuitively understood from a user perspective, but difficult to quantify based on available data. Therefore, achieving certain design parameters in automatically-generated user interface formats may be difficult. In various disclosed embodiments, semi-supervised learning techniques are used to train a machine learning engine such as a neural network based on user input relating to a set of training data.

In some embodiments, users are presented with subsets (e.g., pairs) of a set of training elements and select an element that, from the user's perspective, most exhibits a certain design parameter (e.g., emphasis). The system then applies a ranking technique such as the Bradley-Terry model to rank the training elements. The ranks are used as labels, along with characteristics of the training elements, to train a machine learning engine to independently score subsequently-input elements according to the design parameter.

Various techniques are discussed herein in the context of user interface design, but the disclosed techniques may be implemented in various other contexts, particularly where a higher-level parameter is generally recognizable by humans but difficult to recognize using traditional algorithms.

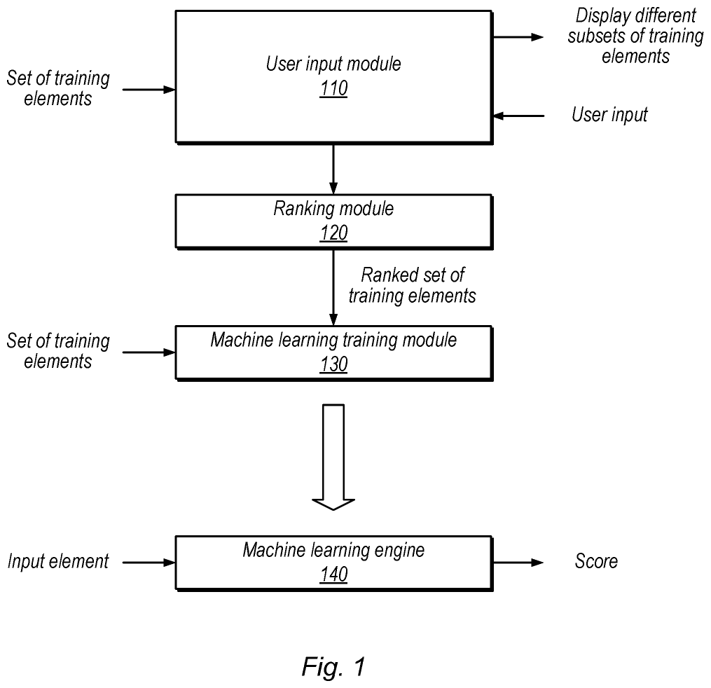

FIG. 1 is a block diagram illustrating an example system configured to train a machine learning engine, according to some embodiments. In the illustrated embodiment, the system includes user input module 110, ranking module 120, and machine learning training module 130, and is configured to train machine learning engine 140.

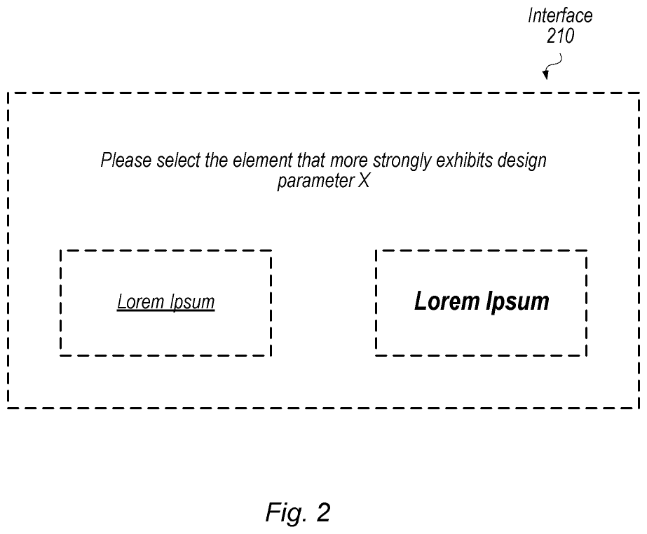

User input module 110, in the illustrated embodiment, receives a set of training elements and causes display of different subsets of the training elements to one or more users. Module 110 also receives user input indicating one or more user interface elements of a displayed subset that more strongly exhibit a specified design parameter (e.g., a specified user interface design parameter such as emphasis) relative to other elements in the subset. User input module 110 then provides information regarding the user input to ranking module 120. Example interfaces that may be used by module 110 are discussed in further detail below with reference to FIG. 2.

Ranking module 120, in the illustrated embodiment, is configured to generate a ranked set of training elements based on the user input from module 110. Ranking module 120 may implement the Bradley-Terry model for ranking a set of elements, for example. The Bradley-Terry model is a well-understood model used to predict the outcome of a paired comparison, which can be used to generate a ranked set of elements based on paired comparisons by users. Although Bradley-Terry techniques are discussed herein for purposes of explanation, any of various other ranking algorithms may be used in other embodiments.

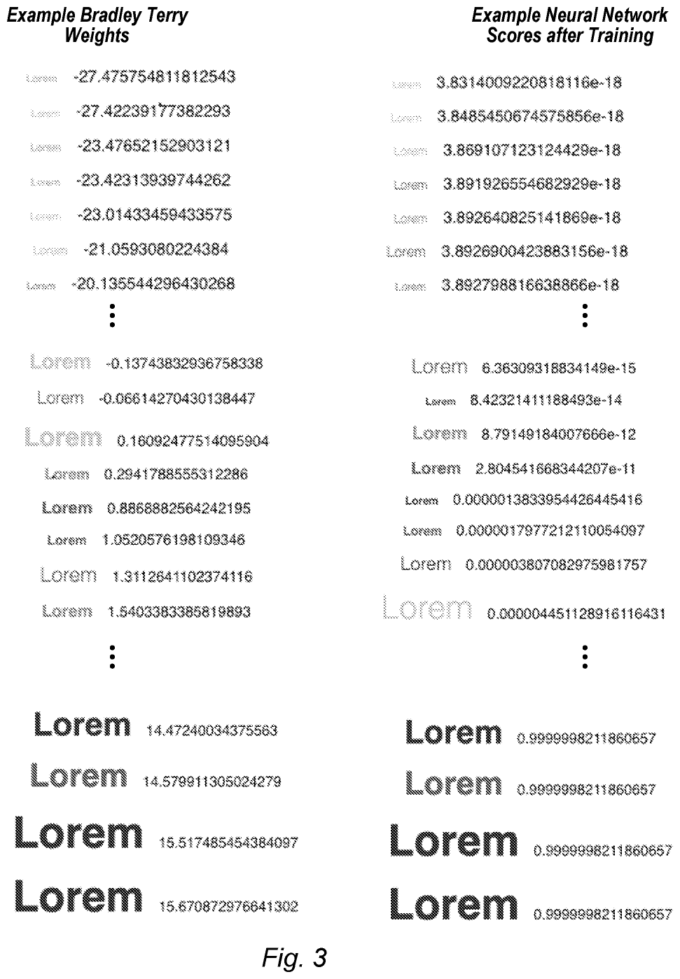

Machine learning training module 130, in the illustrated embodiment, receives information for the set of training elements and the ranked set of training elements from module 120 and trains machine learning engine 140, using the ranked set as label information for the training process. The information for the set of training elements, in the user interface design context, may include various attributes such as font, size, boldness, color, opacity, decoration, etc. The term “label” is intended to be construed according to its well-understood meaning in the machine learning context, which includes correct results to which machine learning outputs can be compared during training (e.g., to reduce or minimize the difference in outputs and labels). Example Bradley-Terry label weights and corresponding machine learning scores after training are discussed in detail below with reference to FIG. 3.

Machine learning engine 140, in the illustrated embodiment, is configured to receive a given input element and provide a score for the design parameter, independently of other elements. Note that these techniques may also be for relative comparisons among multiple elements by scoring each element and comparing the scores. In some embodiments, scoring using machine learning engine 140 may further improve results relative to Bradley-Terry rankings, for example, because outlier results may be incorporated into a more consistent and smooth model.

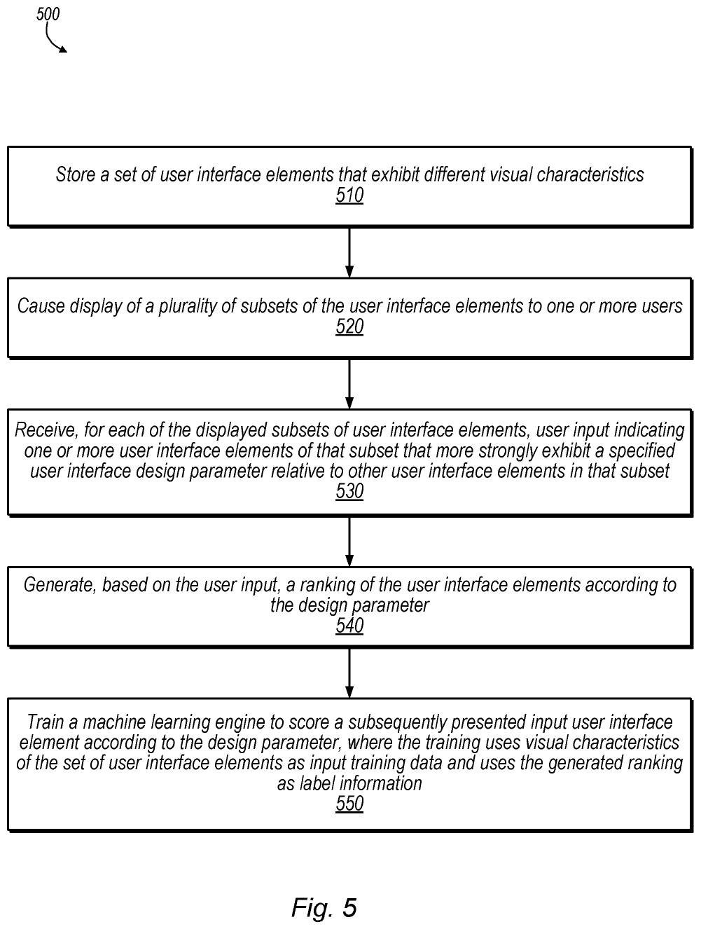

In some embodiments, machine learning engine 140 is an artificial neural network. Neural networks are discussed in further detail with reference to FIG. 5 below. In some embodiments, machine learning engine 140 utilizes a rectified linear unit activation function (e.g., to determine the outputs of nodes in neural network implementations), which may facilitate scaling to new instances outside of the scope of the training samples. Although neural networks are discussed for purposes of explanation, this discussion is not intended to limit the scope of the present disclosure. In other embodiments, any of various machine learning techniques may be implemented, such as, without limitation: vector machines, gradient boosting, naïve Bayes, linear regression, logistic regression, reduction, random forest, etc.

### Example Interface for User Pairwise Comparison

FIG. 2 is a diagram illustrating an example interface 210 for user input, according to some embodiments. In the illustrated embodiment, the phrase “Lorem Ipsum” is displayed using two different formats. In particular, the left-hand element is shown underlined and in italics while the right-hand element is relatively larger and shown in bold. In the illustrated embodiment, the user is prompted to select the element that more strongly exhibits a particular design parameter X. Users may select an element using various types of input devices, including a mouse, touchscreen, or microphone, for example.

The disclosed techniques may be utilized for various different design parameters. Non-limiting examples in the interface context include parameters such as joy, stylishness, modernity, clean design, coziness, boldness, etc. In other contexts, parameters may be specified for various aspects of intellectual or physical design that are difficult to quantify using traditional methods but intuitively understood by users.

In some embodiments, the elements of the subset to be displayed are randomly selected from a set of training elements. In the illustrated embodiment, a pair of elements are displayed, but in other embodiments subsets may include various numbers of elements. Similarly, although the user is prompted to select a single element in the illustrated example, a user may select multiple elements in other embodiments, or provide other types of input (such as a relative ranking of displayed elements, individual scores for each element, etc.) according to the user's opinion. Note that, while certain design parameters may be somewhat subjective, e.g., such that different users might select a different element from a displayed subset for a given design parameter, when using a large enough data set the ranking results may correspond to a consensus for the general population or a given survey group.

### Example Bradley-Terry Weights and Neural Network Scores

FIG. 3 is a diagram illustrating an example Bradley-Terry ranking output and corresponding neural network scores after training, according to some embodiments. In the illustrated example, the smallest Bradley-Terry weight for the set is approximately minus 27.457 and the largest Bradley-Terry weight is approximately 15.670. In the illustrated embodiment, the neural network is configured to provide scores from zero to one where scores closer to one represent greater emphasis relative to scores closer to zero. In other embodiments, various different ranges of outputs are contemplated. In the illustrated example, the smallest neural network score for the training set is approximately 3.831e-18 and the largest neural network score is approximately 0.999.

As shown, the ranking according to the Bradley-Terry weights is not identical to the ranking according to the neural network score weights, particularly towards the middle of the figure. The training may be complete according to a training threshold, however. Note that, generally speaking, the neural network scoring has successfully scored elements with greater emphasis higher than elements with lesser emphasis.

### Example Scoring Interface

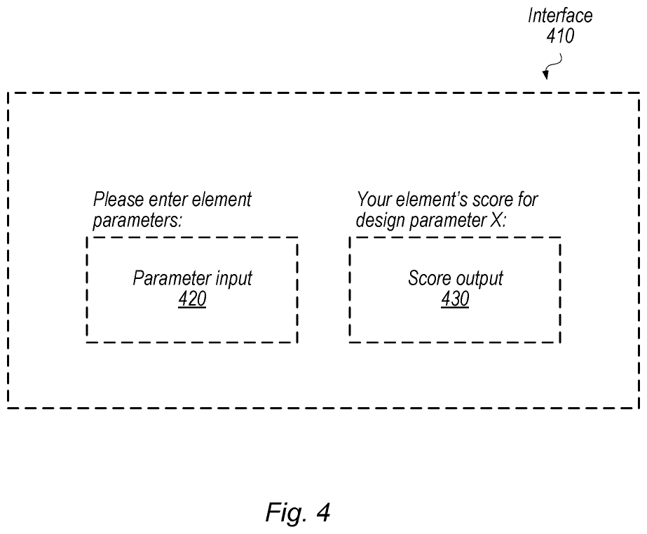

FIG. 4 is a diagram illustrating an example interface 410 for scoring user interface elements, according to some embodiments. In the illustrated embodiment, interface 410 includes a parameter input portion 420 and a score output portion 430.

In the illustrated example, a user is prompted to enter element parameters in portion 420. For example, the user may select font, color, size, etc. via pull down menus, buttons-style elements, text entry, etc. In some embodiments, portion 420 may allow a user to paste code for a CSS object as parameter input. In other embodiments, any of various techniques may be used to enter parameters for a user interface element.

Portion 430, in the illustrated embodiment, shows a score output from the machine learning engine indicating the entered element's score according to a particular design parameter.

Note that the disclosed techniques may also be used in the context of computer-generated user interfaces. For example, when automatically formatting a user interface, a computing system may score available elements according to the disclosed techniques and use the scores to select elements or parameters for the interface.

### Example Method

FIG. 5 is a flow diagram illustrating a method 500 for training a machine learning engine, according to some embodiments. The method shown in FIG. 5 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 510, in the illustrated embodiment, a computer system stores a set of user interface elements that exhibit different visual characteristics

At 520, in the illustrated embodiment, the system causes display of a plurality of subsets of the user interface elements to one or more users. In some embodiments, the subsets are randomly generated. Note that, while true randomness is difficult to achieve using current computing techniques, the term “random,” as used herein includes pseudo-random techniques that meet one or more statistical tests for randomness.

At 530, in the illustrated embodiment, the system receives, for each of the displayed subsets of user interface elements, user input indicating one or more user interface elements of that subset that more strongly exhibit a specified user interface design parameter relative to other user interface elements in that subset. In some embodiments, each subset is a pair of elements and the user input selects one of the elements.

At 540, in the illustrated embodiment, the system generates, based on the user input, a ranking of the user interface elements according to the design parameter. In some embodiments, the system generates the ranking using the Bradley-Terry model.

At 550, in the illustrated embodiment, the system trains a machine learning engine to score a subsequently presented input user interface element according to the design parameter. In the illustrated example, the training uses visual characteristics of the set of user interface elements as input training data and uses the generated ranking as label information. In some embodiments, the machine learning engine is a neural network.

In some embodiments, a method includes scoring, using a machine learning engine that is trained according to the techniques of FIG. 5, a user interface element according to the design parameter.

In various embodiments, the disclosed techniques may advantageously produce a machine learning engine configured to independently score inputs according to a target design parameter, based on user intuition relating to the parameter.

### Neural Network Overview

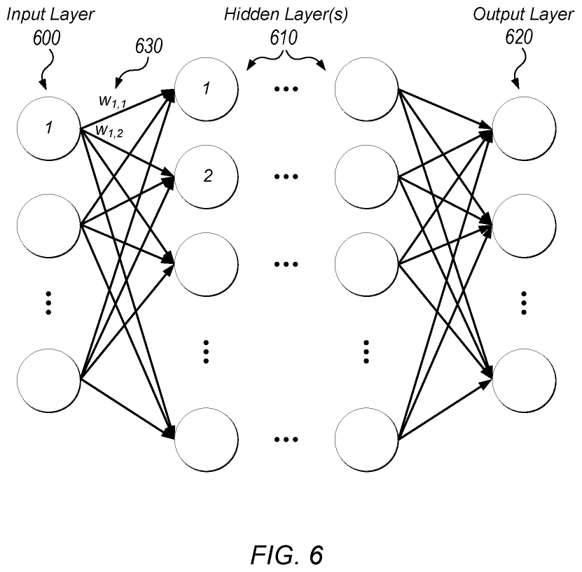

FIG. 6 shows a neural network, a computing structure commonly known in the art. A neural network may be implemented in hardware, (e.g. as a network of processing elements) in software, (e.g. as a simulated network) or otherwise in some embodiments. A neural network is comprised of a set of nodes which receive inputs, process those inputs, and send outputs. In some embodiments, the processing involves combining the received inputs according to a set of weights 630 which the node maintains, and then using that result with an activation function to determine what value to output. A complete neural network may be made up of an Input Layer 600, and Output Layer 620, and one or more Hidden Layers 610. The nodes in the Input Layer 600 and Output Layer 620 present a special case; the input nodes send input values to the nodes in the Hidden Layer(s) and do not perform calculations on those values and the nodes of the Output Layer do not pass along values.

Combining and processing input signals to produce an output can be done in various ways which will be familiar to those skilled in the art. One embodiment involves summing the product of the input value and the respective weight 630 for each node that sends input. This value is then input to an activation function which returns a value to send as output to the next node. In some embodiments, possible activation functions include a sigmoid function or a hyperbolic tangent.

A neural network may be configured to have a variety of connection structures. In some embodiments, as shown in FIG. 6, each node may connect to all of the nodes in the next layer, where “next” indicates towards the right in FIG. 6, and is defined by the direction from input to output. Neural networks may be configured to have an arbitrary number of Hidden Layers, and all layers, including Input and Output Layers, may have an arbitrary number of nodes, as indicated by the ellipses in FIG. 6. In some embodiments, neural networks may have some connections which send information to previous layers or connections which skip layers.

Neural networks typically learn by processing training data. In some embodiments, training data is data which has been labeled so that the output of the neural network can be compared to the labels. Learning may be accomplished by reducing or minimizing a cost function which represents the difference between the labeled results and the neural network outputs; one example is the least squares method. In order to improve results, the connections weights may be changed. One embodiment of this method is referred to as backpropagation; this method involves computing an error term for each connection, moving from the output to the input. Other learning methods will be known to a person skilled in the art.

The output of a neural network may be determined by the number of layers and nodes of the neural network, the connection structure, the set of weights, and the activation functions. Due to the ability of neural networks to learn, uses for them include classification, regression, scoring, and data processing, among others.

### Exemplary Device

In some embodiments, any of various operations discussed herein may be performed by executing program instructions stored on a non-transitory computer readable medium. In these embodiments, the non-transitory computer-readable memory medium may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

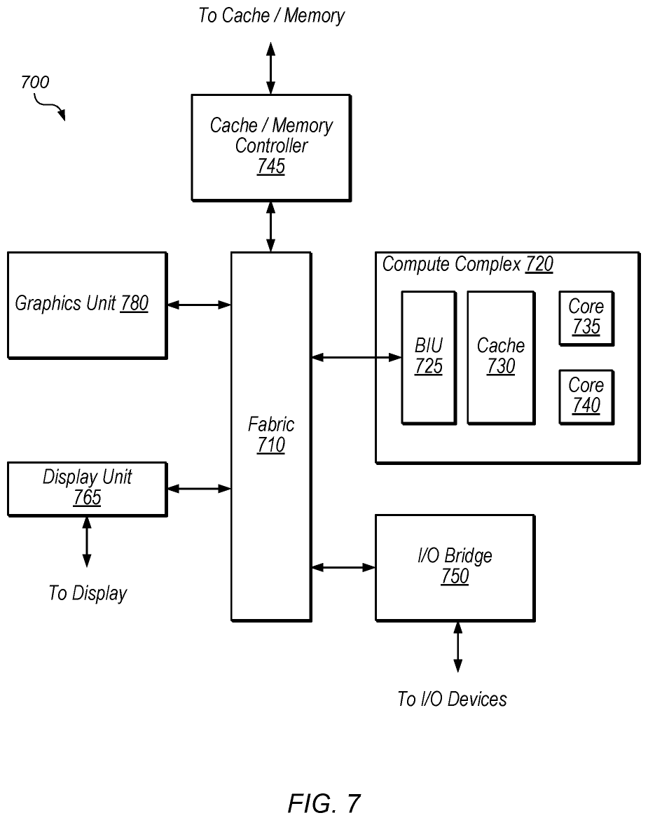

Referring now to FIG. 7, a block diagram illustrating an exemplary embodiment of a device 700 is shown. The illustrated processing elements may be used to implement all or a portion of the system of FIG. 1, in some embodiments. In some embodiments, elements of device 700 may be included within a system on a chip. In the illustrated embodiment, device 700 includes fabric 710, compute complex 720, input/output (I/O) bridge 750, cache/memory controller 745, graphics unit 780, and display unit 765.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and/or caches. For example, compute complex 720 may include 1, 2, or 4 processor cores, or any other suitable number. In one embodiment, cache 730 is a set associative L2 cache. In some embodiments, cores 735 and/or 740 may include internal instruction and/or data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions.

Cache/memory controller 745 may be configured to manage transfer of data between fabric 710 and one or more caches and/or memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches.

As used herein, the term “coupled to” may indicate one or more connections between elements, and a coupling may include intervening elements. For example, in FIG. 7, graphics unit 780 may be described as “coupled to” a memory through fabric 710 and cache/memory controller 745. In contrast, in the illustrated embodiment of FIG. 7, graphics unit 780 is “directly coupled” to fabric 710 because there are no intervening elements.

Graphics unit 780 may include one or more processors and/or one or more graphics processing units (GPU's). Graphics unit 780 may receive graphics-oriented instructions, such as OPENGL® or DIRECT3D® instructions, for example. Graphics unit 780 may execute specialized GPU instructions or perform other operations based on the received graphics-oriented instructions. Graphics unit 780 may generally be configured to process large blocks of data in parallel and may build images in a frame buffer for output to a display. Graphics unit 780 may include transform, lighting, triangle, and/or rendering engines in one or more graphics processing pipelines. Graphics unit 780 may output pixel information for display images.

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and/or low-power always-on functionality, for example. I/O bridge 750 may also include interfaces such as pulse-width modulation (PWM), general-purpose input/output (GPIO), serial peripheral interface (SPI), and/or inter-integrated circuit (I2C), for example. Various types of peripherals and devices may be coupled to device 700 via I/O bridge 750.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

1. A method, comprising:
storing, by a computer system, a set of user interface elements that exhibit different visual characteristics;
causing display, by the computer system, of a plurality of subsets of the user interface elements to one or more users;
receiving, by the computer system for each of the displayed subsets of user interface elements, user input indicating one or more user interface elements of that subset that more strongly exhibit a specified user interface design parameter relative to other user interface elements in that subset;
generating, by the computer system based on the user input, a ranking of the user interface elements according to the design parameter; and
training, by the computer system, a machine learning engine to score a subsequently presented input user interface element according to the design parameter, wherein the training uses visual characteristics of the set of user interface elements as input training data and uses the generated ranking as label information to generate adjustments to the machine learning engine based on differences between the label information and outputs of the machine learning engine during training; and
automatically generating a user interface, including:
scoring, using the trained machine learning engine, a set of user interface elements with different formatting characteristics; and
selecting, based on the scoring, one user interface element of the set of user interface elements for inclusion in the user interface.

2. The method of claim 1, wherein the user interface design parameter indicates emphasis of a user interface element.

3. The method of claim 1, wherein the machine learning engine is a neural network.

4. The method of claim 1, wherein the generating the ranking uses a Bradley-Terry probability model.

5. The method of claim 1, further comprising:
randomly generating the subsets of user interface elements.

6. (canceled)

7. The method of claim 1, wherein the machine learning engine uses rectified linear unit activation.

8. The method of claim 1, wherein each of the subsets include a pair of user interface elements and the user input selects one of the user interface elements.

9. A method, comprising:
receiving, by a computer system, a set of parameters for a set of user interface elements; and
scoring, by the computer system using a machine learning engine that receives the set of parameters as input, the user interface elements according to a design parameter; and
automatically generating a user interface, including selecting, based on the scoring, one user interface element of the set of user interface elements for inclusion in the user interface;
wherein the machine learning engine was trained, prior to the scoring, by:
storing a set of user interface elements that exhibit different visual characteristics;
causing display of a plurality of subsets of the user interface elements to one or more users;
for each of the displayed subsets of user interface elements, receiving user input indicating one or more user interface elements of that subset that more strongly exhibit the design parameter relative to other user interface elements in that subset;
generating, based on the user input, a ranking of the user interface elements according to the design parameter; and
training the machine learning engine using parameters of the set of user interface elements as input training data and using the generated ranking as label information to generate adjustments to the machine learning engine based on differences between the label information and outputs of the machine learning engine during training.

10. The method of claim 9, wherein the design parameter indicates emphasis of a user interface element.

11. The method of claim 9, wherein the machine learning engine is a neural network.

12. The method of claim 9, wherein the scoring a given user interface element is performed independently of other user interface elements.

13. A non-transitory computer-readable medium having instructions stored thereon that are executable by a computing device to perform operations comprising:
storing a set of user interface elements that exhibit different visual characteristics;
causing display of a plurality of subsets of the user interface elements to one or more users;
for each of the displayed subsets of user interface elements, receiving user input indicating one or more user interface elements of that subset that more strongly exhibit a specified user interface design parameter relative to other user interface elements in that subset;
generating, based on the user input, a ranking of the user interface elements according to the design parameter; and
training a machine learning engine to score a subsequently presented input user interface element according to the design parameter, wherein the training uses visual characteristics of the set of user interface elements as input training data and uses the generated ranking as label information to generate adjustments to the machine learning engine based on differences between the label information and outputs of the machine learning engine during training; and
automatically generating a user interface, including:
scoring, using the trained machine learning engine, a set of user interface elements with different formatting characteristics; and
selecting, based on the scoring, one user interface element of the set of user interface elements for inclusion in the user interface.

14. The non-transitory computer-readable medium of claim 13, wherein the user interface design parameter indicates emphasis of a user interface element.

15. The non-transitory computer-readable medium of claim 13, wherein the machine learning engine is a neural network.

16. The non-transitory computer-readable medium of claim 13, wherein the generating the ranking uses a Bradley-Terry probability model.

17. The non-transitory computer-readable medium of claim 13, wherein the operations further comprise:
randomly generating the subsets of user interface elements.

18. (canceled)

19. The non-transitory computer-readable medium of claim 13, wherein the machine learning engine uses rectified linear unit activation.

20. The non-transitory computer-readable medium of claim 13, wherein each of the subsets include a pair of user interface elements and the user input selects one of the user interface elements.
